(19) United States
(12) Patent Application Publication
(10) Pub. No.: US 2005/0199620 A1
(43) Pub. Date: Sep. 15, 2005

(54) Microwave popcorn caddy

(76) Inventor: David Fish, Santa Clarita, CA (US)

Correspondence Address: Matthew J. Peirce, Esq., 330 S. 3rd St. #1005, Las Vegas, NV, 89101, US

(21) Appl. No.: 11/141,111

(22) Filed: May 31, 2005

Related U.S. Application Data
(60) Provisional application No. 60/650,100, filed on Feb. 7, 2005.

(51) Int. Cl. H05B 6/80

(52) U.S. Cl. 219/730

(57) ABSTRACT

An apparatus for addicting an individual when cooking popcorn in a microwave. The apparatus is a stand that allows an individual to mount a bag of uncooked microwave popcorn off of the floor surface within the microwave. The stand comprises a continuous band and is diamond-shaped.

### I. CROSS-REFERENCE TO RELATED APPLICATIONS

This application claims the benefit of U.S. Provisional Application No. 60/650,100 filed Feb. 7, 2005.

### II. BACKGROUND OF THE INVENTION

The present invention concerns that of a new and improved apparatus for addicting an individual when cooking popcorn in a microwave.

### III. DESCRIPTION OF THE PRIOR ART

U.S. Pat. No. 5,357,086, issued to Turpin et al., discloses a collapsed flexible bag which contains a charge of unpopped popcorn.

U.S. Pat. No. 5,200,590, issued to Bowen et al., discloses an apparatus and method for popping high yield popcorn using a bag having a substantially rectangular cross section as manufactured using a conventional bag machine.

U.S. Pat. No. 4,477,705, issued to Danley et al., discloses a cooking utensil for a microwave oven.

### IV. SUMMARY OF THE INVENTION

The present invention concerns that of a new and improved apparatus for addicting an individual when cooking popcorn in a microwave. The apparatus is a stand that allows an individual to mount a bag of uncooked microwave popcorn off of the floor surface within the microwave. The stand comprises a continuous band and is diamond-shaped.

There has thus been outlined, rather broadly, the more important features of a cooking assistance apparatus that the detailed description thereof that follows may be better understood and in order that the present contribution to the art may be better appreciated. There are, of course, additional features of the cooking assistance apparatus that will be described hereinafter and which will form the subject matter of the claims appended hereto.

In this respect, before explaining at least one embodiment of the cooking assistance apparatus in detail, it is to be understood that the cooking assistance apparatus is not limited in its application to the details of construction and to the arrangements of the components set forth in the following description or illustrated in the drawings. The cooking assistance apparatus is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present cooking assistance apparatus. It is important, therefore, that the claims be regarded as including such equivalent constructions insofar as they do not depart from the spirit and scope of the present invention.

It is therefore an object of the present invention to provide a cooking assistance apparatus which has all of the advantages of the prior art and none of the disadvantages.

It is another object of the present invention to provide a cooking assistance apparatus which may be easily and efficiently manufactured and marketed.

It is another object of the present invention to provide a cooking assistance apparatus which is of durable and reliable construction.

It is yet another object of the present invention to provide a cooking assistance apparatus which is economically affordable and available for relevant market segment of the purchasing public.

Other objects, features and advantages of the present invention will become more readily apparent from the following detailed description of the preferred embodiment when considered with the attached drawings and appended claims.

### V. BRIEF DESCRIPTION OF THE DRAWINGS

FIG. 1 shows a perspective view of the popcorn stand.

FIG. 2 shows a perspective view of the popcorn stand as it would appear in use.

### VI. DESCRIPTION OF THE PREFERRED EMBODIMENT

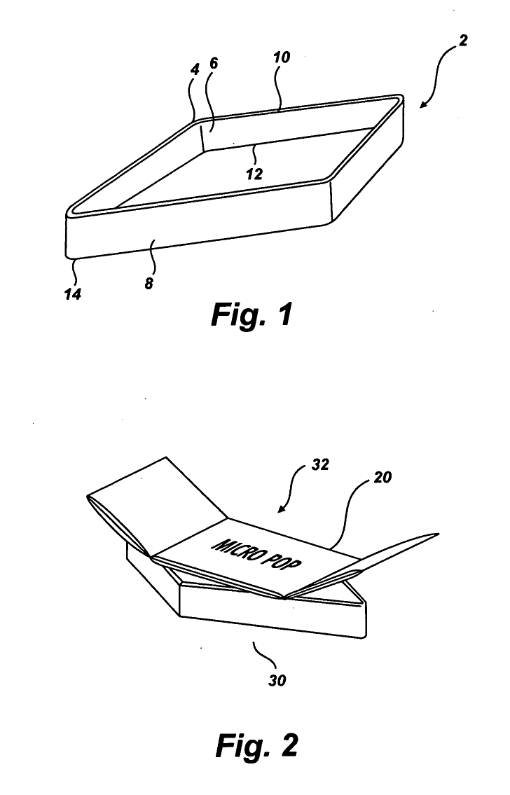

FIG. 1 shows a perspective view of the popcorn stand 2. Popcorn stand 2 comprises a continuous band 4 that has two surfaces, an inner surface 6 and an outer surface 8. Furthermore, the continuous band 4 has two sides comprising a top side 10 and a bottom side 12.

Stand 2 itself can have a wide variety of shapes. However, the preferred shape for stand 2 is that of a diamond shape 14. This diamond shape 14 can be seen in FIG. 1.

Stand 2 itself can have a wide variety of lengths and/or widths. However, the main consideration is for stand 2 to be able to fit into a microwave oven. Stand 2, therefore, has a preferable length of ten inches and a width of five inches. These dimensions will give the stand 2 enough of a size to appropriately act as a stand, while at the same time, make the dimensions small enough to allow the stand 2 to fit into a microwave.

Furthermore, the stand 2 can have a wide variety of heights. However, the main consideration, once again, is for stand 2 to be able to fit into a microwave oven. Stand 2, therefore, has a preferable height of one inch. This dimension will give the stand 2 enough of a size to appropriately act as a stand, while at the same time, make the dimensions small enough to allow the stand 2 to fit into a microwave.

FIG. 2 shows a perspective view of the popcorn stand 2 as it would appear in use with a bag of microwave popcorn 20. To properly be used, the stand 2 is first placed on a floor surface 30 within a microwave 32. Then, the bag of microwave popcorn 20 is unfolded and placed on top of the stand 2. Finally, an individual would close the microwave door and input the appropriate amount of time necessary to properly cook the bag of microwave popcorn.

By using stand 2, an individual elevates the bag of popcorn off the bottom of the microwave oven or glass tray. Furthermore, stand 2 also eliminates the transfer of the heat from the floor surface 30 of the microwave oven so that the hot oil in the bag of microwave popcorn 20 will not scorch or burn the popcorn.

1. A cooking apparatus comprising:
(a) a popcorn stand comprising a continuous band, the continuous band having two surfaces, an inner surface and an outer surface, the continuous band also having two sides, a top side and a bottom side,
(b) wherein the stand has a length and a width,
(c) further wherein the stand has a preferred shape,
(d) further wherein the stand has a height,
(e) further wherein the stand is placed in a microwave oven, and
(f) further wherein a bag of microwave popcorn to be cooked in the microwave oven is placed on top of the stand.

2. A cooking apparatus according to claim 1 wherein the shape of the stand is that of a diamond.

3. A cooking apparatus according to claim 2 wherein the length of the stand is ten inches.

4. A cooking apparatus according to claim 3 wherein the width of the stand is five inches.

5. A cooking apparatus according to claim 4 wherein the height of the stand is one inch.
